(19) United States
(12) Patent Application Publication
(10) Pub. No.: US 2012/0139707 A1
(43) Pub. Date: Jun. 7, 2012

(54) SUPPORTED RADIO FREQUENCY IDENTIFICATION (RFID) TAG

(75) Inventors: Gregory M. Stewart, Steilacoom, WA (US); Gregory L. Snead, Puyallup, WA (US)

(73) Assignee: ORBITER, LLC, Tacoma, WA (US)

(21) Appl. No.: 12/962,399

(22) Filed: Dec. 7, 2010

(51) Int. Cl. H04Q 5/22

(52) U.S. Cl. 340/10.1

(57) ABSTRACT

A supported RFID tag that positions the antenna of the RFID tag away from an object identified by the tag. In one form, the support includes a flat, relatively rigid sheet and a bumper. The antenna of the RFID tag is supported by one end of the flat sheet and a hole is located in the other end. When tightly attached to an object via the hole, the bumper causes the antenna portion to be positioned away from the object. In another form, a semi-rigid support is rotated into a cylinder or truncated cone. The antenna portion of the RFID tag is positioned such that when the support sheet is attached to an object, at least the antenna portion is positioned away from the object. In another form, the inner surfaces of the opposed ends of the semi-rigid support sheet create a loop.

When the overlying ends of the loop are attached to an object the antenna portion is positioned away from the object. In still another form, the semi-rigid tag includes an outwardly bent flap that supports the antenna portion. As a result, when the surrounding portion of the support is attached to an object, the antenna portion is positioned away from the object.

### BACKGROUND

Radio frequency identification (RFID) tags are used in a variety of industries for a variety of purposes. Some RFID tags, often the size of credit cards, are used as access “keys” that are readable by an access reader that controls access to restricted buildings or areas of buildings. In recent years, RFID tags have been used to identify sports participants, such as runners. Each time a runner passes an RFID reader during a lap around a track, for example, the passage is recorded. See U.S. Pat. No. 7,605,685 for an exemplary discussion of such usage of RFID tags. Other RFID tags are used in place of barcodes to identify objects. Much like barcodes, such tags are attached to the object being identified. Identification information carried by the RFID tag is read by an electronic device called a reader or interrogator. The advantages of RFID tags over barcodes include: (1) RFID tags can be read without being within a direct line of sight of the reader, (2) RFID tags are more rugged—the “code” doesn't wear off and can be read without light—i.e., they are not as vulnerable to wear and tear; and (3) RFID tags can be read must faster than bar codes.

The readability distance between an RFID tag and a reader or interrogator is dependent on the nature of the RFID tag. More specifically, there are three types of RFID tags: passive RFID tags, which have no power source and require an external electromagnetic field to initiate a signal transmission; active RFID tags, which contain a battery and can transmit signals once an external source (“interrogator”) has been successfully identified; and battery-assisted passive (BAP) RFID tags, which require an external source to wake up but have significant higher forward link capability, providing greater range.

Tags also vary depending on the radio frequency used by the reader or interrogator. The RF frequency used can produce limitations on how a tag operates. A tag used for access to a building may only have a range of 1 inch, or a tag implanted in an animal must be readable subdermally. Some tags, because they are flat, will lie against the object to which they are attached, such as the running shoes of a runner. This orientation of RFID tags can make it difficult to read RFID tags because the antenna of the tags lies against the object to be identified. Obviously, it would be desirable to improve the readability of RFID tags. The subject matter of this disclosure is directed to achieving this result.

### SUMMARY

The disclosed subject matter is directed to improving the readability of radio frequency identification (RFID) tags. Readability is improved by affixing an RFID tag to a support that positions at least the antenna portion of the RFID tag away from the object identified by the RFID tag. The RFID tag can be attached to a surface of the support or embedded in the support.

In one form, the RFID tag is supported on (or in) a flat and relatively rigid sheet. A protrusion, called a bumper, is located on at least one side of the flat, relatively rigid sheet, near one end thereof. For ease of use, preferably, two aligned bumpers, one positioned on each side of the flat, relatively rigid sheet, near one end thereof, are included. Regardless, a hole located in the smaller end of the flat, relatively rigid sheet is used to attach the support to the object to be identified, such as the shoe of a runner, a wire harness, etc. When tightly attached, the bumper acts as a fulcrum that causes the larger end of the rigid sheet to be rotated outwardly, away from the object to be identified. The antenna portion of the RFID tag is located in the larger end. As a result, at least the antenna portion of the RFID tag is positioned away from the object to be identified, thereby making the RFID tag more easily read by a suitable RFID tag reader.

In another form, the support is semi-rigid and elongate. The semi-rigidity is such that the elongate support can be formed into a cylinder or truncated cone. Alternatively, the elongate support can be formed into a loop. In a still further form, the support is generally square and planarized includes a tab attached along one edge so as to be rotatable outwardly, away from the plane of the support.

Regardless of the version, the RFID tag is positioned on the support such that when the support is attached to an object, at least the antenna portion of the RFID tag is positioned away from the object. In the case of the cylinder or truncated cone version, holes located in opposed corners overlap when the semi-rigid elongate support is formed into a cylinder or truncated cone. The overlapping holes are used to attach the cylinder or truncated cone to an object. At least the antenna portion of the RFID tag is located on (or in) the portion of the cylinder or truncated cone furthest away from the object. In the case of the loop version, the inner surface of the ends of the elongate support are juxtaposed, and the juxtaposed ends of the loop are attached to an object. When so attached, at least the antenna portion of the RFID tag is positioned away from the object. In the case of the tab version, when the tab is extended outwardly and the planar portion of the support is attached to an object, at least the antenna portion of the RFID tag, which is located in the tab, is positioned away from the object.

As will be readily appreciated from the foregoing summary, the various embodiments of the disclosed subject matter all position at least the antenna portion of the RFID tag away from the object to be identified. This positioning improves the readability of the RFID tag.

### DESCRIPTION OF THE DRAWINGS

The foregoing and many of the attendant features of the disclosed subject matter will be better understood by reference to the following detailed description, when considered in conjunction with the accompanying drawings, wherein:

FIG. 1 is a pictorial view illustrating a runner having a supported RFID tag attached to the lace of a runner's shoe passing an RFID reader;

FIG. 2 is an enlarged view of the runner's shoe and the supported RFID tag illustrated in FIG. 1;

FIG. 3 is an exploded view of the RFID tag support illustrated in FIGS. 1 and 2;

FIG. 4 is an assembled view of the RFID tag support illustrated in FIGS. 1 and 2;

FIG. 5 is a partial cross-sectional view of FIG. 3 taken through the longitudinal plane of the bumper of the RFID tag support;

FIG. 6 is a partial cross-sectional view of FIG. 4 taken through the longitudinal plane of the bumper of the RFID tag support;

FIG. 7 is a pictorial view of a runner's shoe similar to FIG. 2 and an alternative supported RFID tag where the support is a cylinder or truncated cone;

FIG. 8 is a plan view of a supported RFID tag of the type illustrated in FIG. 7 in combination with a bib suitable for attachment to a runner where the tag is removable from the bib and attachable to a runner's shoe as a cylinder or truncated cone;

FIG. 9 is a pictorial view of one side of a supported RFID tag of the type illustrated in FIG. 7 prior to being formed into a cylinder or truncated cone;

FIG. 10 is a pictorial view of the other side of the supported RFID tag illustrated in FIG. 9 prior to being formed into a cylinder or truncated cone;

FIG. 11 is a pictorial view of supported RFID tags attached to the wires of a wire harness;

FIG. 12 is an enlarged view of a supported RFID tag of the type illustrated in FIG. 11;

FIG. 13 is a side view of the supported RFID tag illustrated in FIG. 12 illustrating the bumper acting as a fulcrum to raise the RFID antenna from the wire that might ground it out if the tag rested against it;

FIG. 14 is a pictorial view of supported RFID tags attached to the ends of logs;

FIG. 15 is a side view of one of the supported RFID tags illustrated in FIG. 14;

FIG. 16 is a pictorial view of a different type of supported RFID tag attached to the ends of logs; and

FIG. 17 is a side view of one of the supported RFID tags illustrated in FIG. 16 illustrating the tab is extended outwardly and raising the RFID antenna off the planar surface to which it is attached.

### DETAILED DESCRIPTION

As will be better understood from the following description, a plurality of embodiments of supported RFID tags are disclosed. Each embodiment includes a radio frequency identification (RFID) tag mounted on, or housed in, a support. The supports are configured such that at least the antenna portion of the RFID tag is spaced away from the object being identified when the support is attached to the object. While the various objects are shown as a runner's shoe, a single wire of a wire harness, and timber logs, as will be readily appreciated to those skilled in the art and others, these examples should be taken as exemplary and not as limiting since the various disclosed embodiments can be used to identify other types of objects.

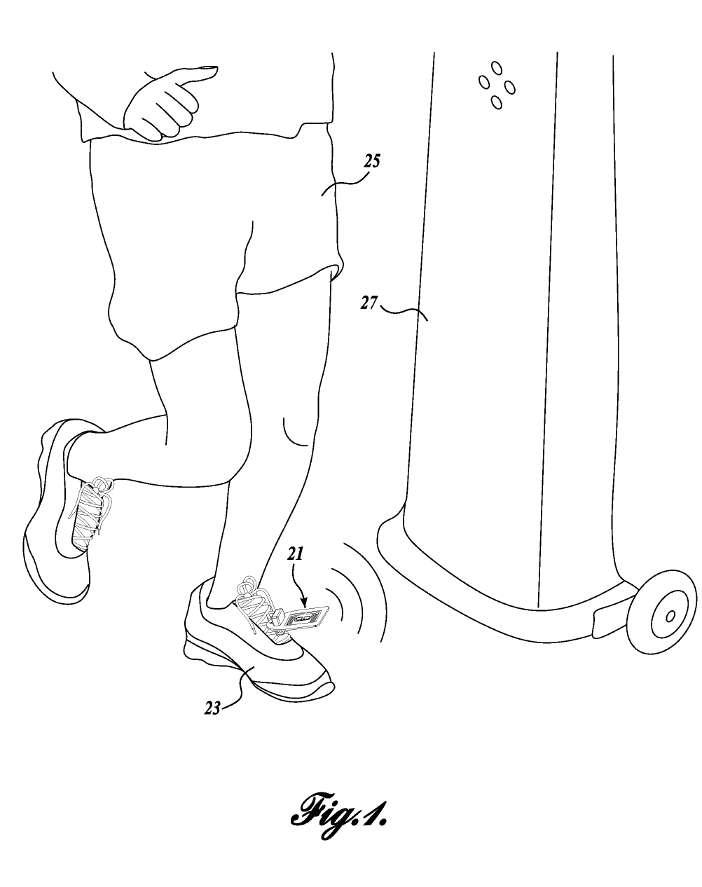

FIG. 1 illustrates a first supported RFID tag embodiment 21 attached to a shoe 23 of a runner 25. The runner is passing an RFID reader 27, also called an interrogator.

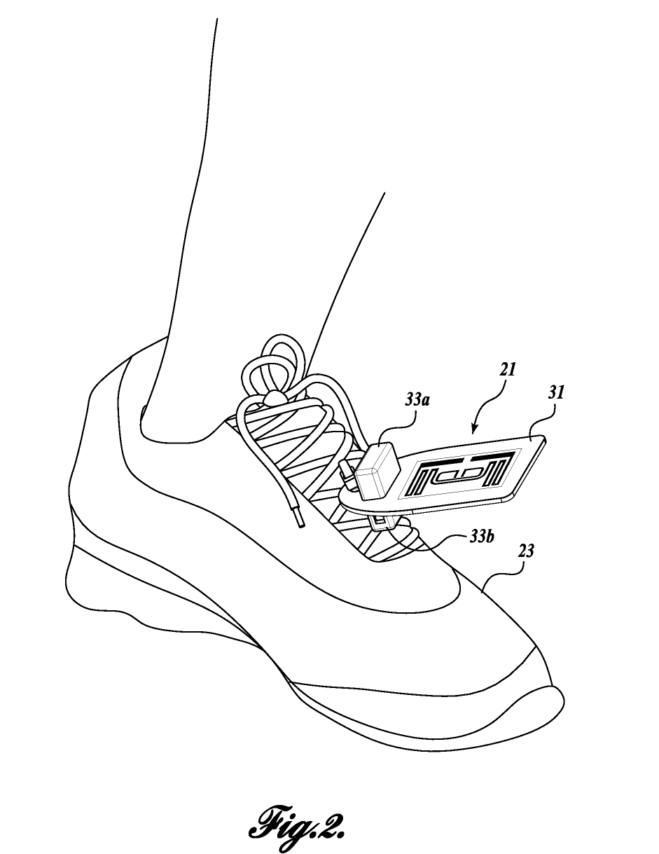

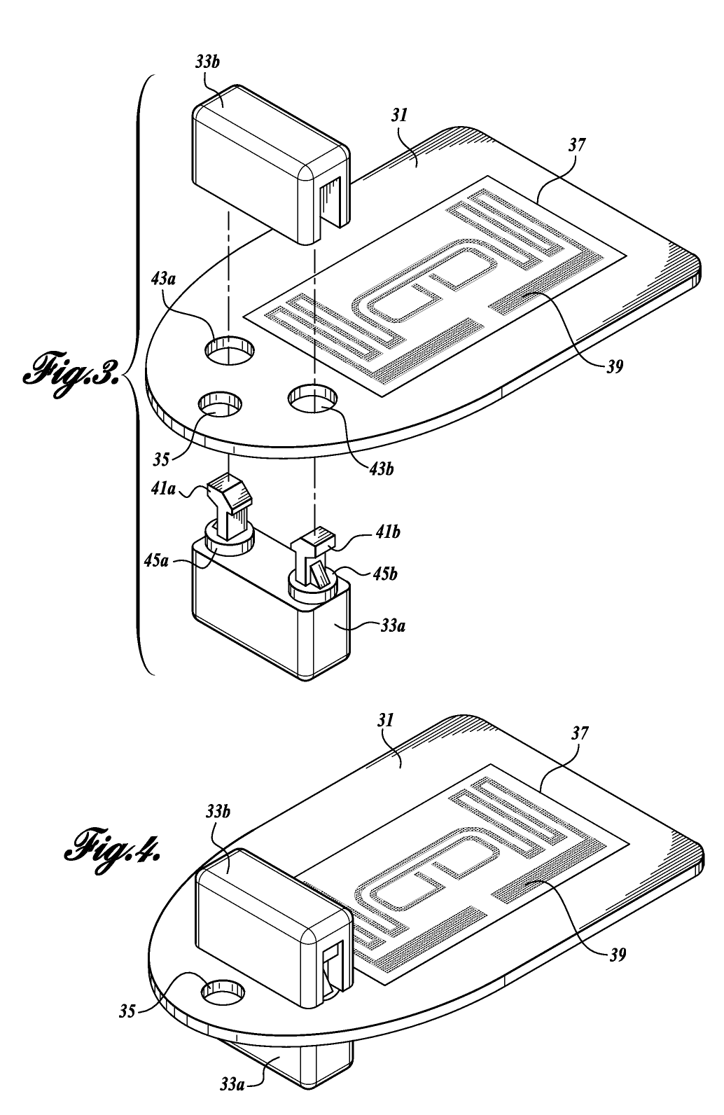

As best shown in FIG. 2, the first supported RFID tag embodiment 21 includes a support formed of a relatively rigid sheet 31 and a pair of aligned bumpers 33a and 33b located on opposite sides of the relatively rigid sheet 31, near one end thereof. The relatively rigid sheet 31 may be formed of a relatively rigid sheet of plastic, for example. The relatively rigid sheet 31 can take on various planar shapes. The illustrated exemplary planar shape is generally rectangular at one end and curved at the other end. The bumpers 33a and 33b, which may also be formed of plastic, are aligned with one another and located on opposite sides of the sheet 31, near the curved end thereof. Located between the bumpers 33a and 33b and the curved end of the sheet 31 is an attachment hole 35. Located on (or in) the larger portion of the sheet 31, which is located on the opposite side of the bumper from the hole 35, is an RFID tag 37, the antenna portion of which is shown in outline form in FIGS. 1-4. While two bumpers are illustrated in this embodiment of the supported RFID tag, as will be understood for the following discussion, only one is needed. Two are preferred because two bumpers create a mirror image support that makes attachment with less detailed instructions easier to accomplish.

While the bumpers 33a and 33b can be affixed to the sheet 31 by an adhesive, if desired, other attachment mechanisms may be used, an example of which is shown in FIGS. 3-6.

The attachment examples shown in FIGS. 3-6 include a pair of feet 41a and 41b integrally formed with one of the bumpers 33a. The feet 41a and 41b project outwardly from the side of the bumper 33a juxtaposed against one surface of the sheet 31. The feet 41a and 41b extend through holes 43a and 43b suitably positioned in the sheet 31. Preferably, the feet 41a and 41b each includes a cylindrical base area 45a and 45b configured to fit and fill in the holes 43a and 43b. The base areas 45a and 45b are equal in height to the thickness of the sheet 31.

The remainder of the feet 41a and 41b extend outwardly from the other side of the sheet 31, into side apertures 47a and 47b formed in the other bumper 33b. The feet 41a and 41b and the side apertures 47a and 47b are formed and positioned such that they snap join together. In this regard, the feet 41a and 41b include enlarged heads having inwardly projecting protrusions 51a and 51b that overlie outwardly extending protrusions 53a and 53b, respectively, formed in the side apertures 47a and 47b. When the first and second bumpers 33a and 33b are snap connected together, as best illustrated in

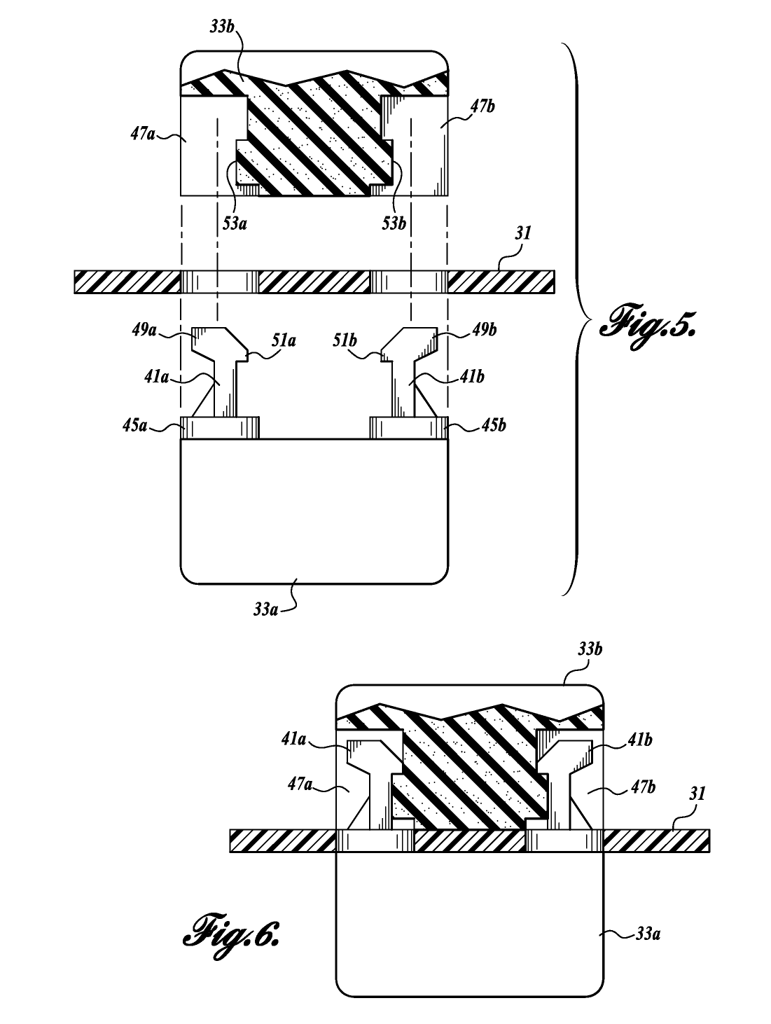

FIG. 6, they are juxtaposed against opposite sides of the rigid sheet 31 Like the rigid sheet 31, as noted above, while the bumpers 33a and 33b can be formed of various materials, preferably, they are formed of a plastic material that allows the legs 41a and 41b to have rigidity sufficient to move outwardly by a slight amount when the first and second bumpers 33a and 33b are pressed toward one another, until the snap connection takes place.

As best illustrated in FIG. 2, the rigid sheet 31 is attached to the shoe 23 of the runner via the hole 35 located in the curved end thereof. While various attachment devices can be used, preferably, a zip tie (also called a wire tie) is used to tightly attach the rigid sheet and thus the support to the lace of the runner's shoe. When the support structure is tightly attached, one of the bumpers is pressed against the runner's shoe. The pressed bumper acts as a fulcrum that rotates the portion of the sheet 31 that includes the antenna portion of the RFID tag 37 outwardly. As a result, the antenna portion of the RFID tag is positioned away from the runner's shoe. The RFID tag, including the antenna portion, can be layered on one of the surfaces of the rigid sheet 31 or embedded in the sheet 31. While two bumpers 33a and 33b are illustrated, as noted above, the FIGS. 1-6 embodiment only requires one bumper. As also noted above, the inclusion of two bumpers allows the supported RFID tag to be attached to a runner's shoe with minimal instructions.

While not shown, if desired, the surfaces of the rigid sheet 31 may include advertising graphics, such as the name of the sponsor of a race or a barcode whose coding corresponds to the coding of the RFID tag, or both.

Since RFID tags are well known, they are not described in detail here. As readily understood by those skilled in the art, RFID tags, also known as RFID labels, contain two parts. One part is an integrated circuit for storing and processing information, modulating and demodulating the radio frequency (RF) signal, and other specialized functions. The other part is an antenna for receiving and transmitting the RF signal. As noted above, in general, there are three types of RFID tags: passive RFID tags, which have no power source and require an external electromagnetic field to initiate a signal transmission; active RFID tags, which contain a battery and can transmit signals once an external source, i.e., a reader, has been successfully identified; and battery-assisted passive (BAP) RFID tags, which require an external source to wake up but have sufficient higher forward link capability providing greater range. Any or all of these types of RFID tags can be used in the various embodiments of the invention, depending upon the desired use.

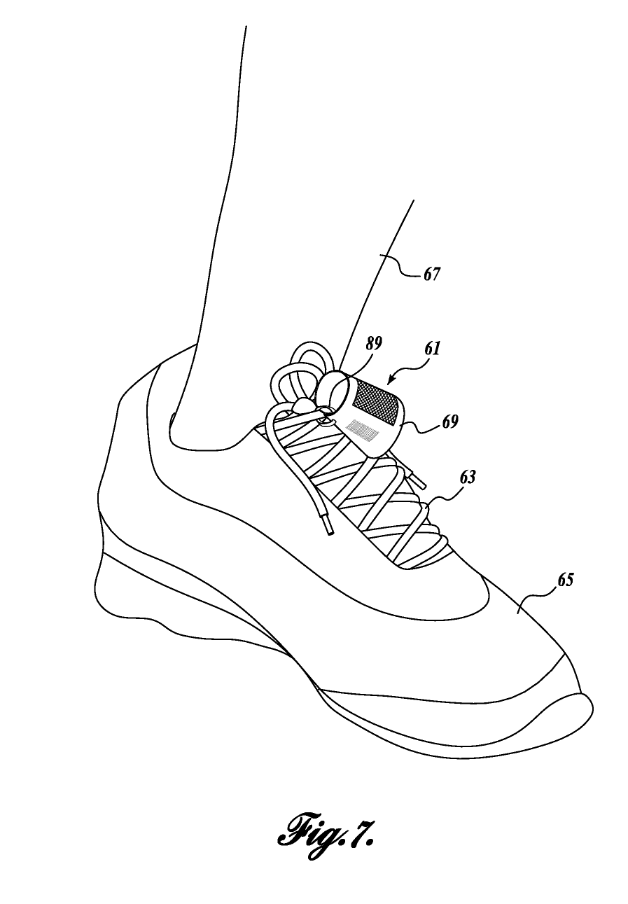

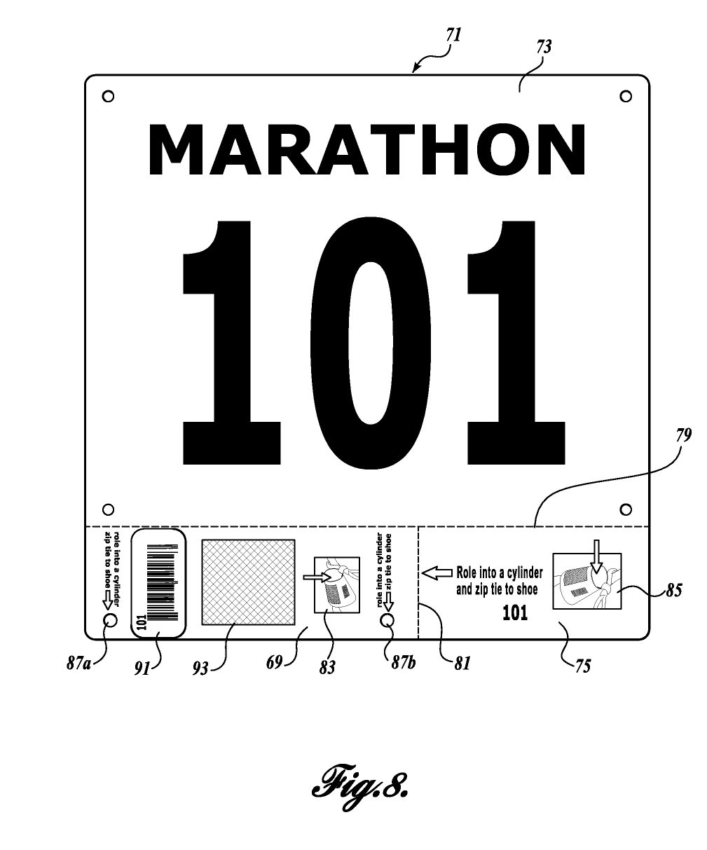

FIGS. 7-10 illustrate an alternate supported RFID tag embodiment 61 that is also shown as attached to the laces 63 of a shoe 65 of a runner 67. This embodiment includes a semi-rigid, elongate support 69 that is rotatable into a cylinder or truncated cone, as best illustrated in FIG. 7. The elongate support 69 may be part of a larger sheet 71 that also includes a runner bib 73 and an instruction section 75 (FIG. 8) or a separate item 77 (FIGS. 9 and 10).

When combined with a runner's bib 73, the support 69 is separable from the bib 73 along a perforation line 79 Likewise, the instruction section 75 is separable from the support 69 along a separation line 81. The RFID tag (not shown in FIG. 8) is affixed as a layer on one side of the semi-rigid support 69 formed of a suitable material, such as a semi-rigid plastic. Alternatively, the RFID tag can be embedded in the semi-rigid support 69. Both the semi-rigid support 69 and the RFID tag are sufficiently flexible to be rotated into a cylinder or truncated cone as shown in FIG. 7 and depicted in images 83 and 85 shown in FIG. 8.

Located near an adjacent longitudinal edge of the elongate support 69, near either end thereof, are a pair of holes 87a and 87b. The elongate support 69 is rotated into a truncated cone or a cylinder such that the holes are brought into alignment. The truncated cone or cylinder acts as the fulcrum elevates the RFID tag, thereby improving the readability. The aligned holes are connected to the lace 63 of the runner's shoe 65 using a suitable tie, such as a zip tie 89, as best shown in FIG. 7. The position of the holes also makes attachment with less detailed instructions easier to accomplish.

If desired, the outer surface of the elongate support 69 may include a barcode 91 and/or an advertising region 93 that includes, for example, the logo of the sponsor of a race. Regardless, the RFID tag is positioned on the elongate support such that when the elongate support is rotated into a cylinder or truncated cone and attached to a runner's shoe as shown in FIG. 7, the RFID tag is located on the portion of the cone spaced from the runner's shoe.

The variation illustrated in FIGS. 9 and 10 is similar to the embodiment shown in FIG. 8, except that the elongate support 77 is not attached to a bib or instruction section. FIG. 10 illustrates the position of an RFID tag 95, including the antenna portion, attached to what becomes the inside surface of the elongate support 77 when the elongate support 77 is rotated into a truncated cone or cylinder. Alternatively, the RFID tag can be attached to the outer surface of the elongate support or embedded in the elongate support. As with the FIG. 8 variation, the FIGS. 9 and 10 variation includes holes 97a and 97b located on opposite ends of the elongate support 77, near one of the longitudinal edges thereof. In addition, as with the FIG. 8 variation, an instruction diagram 99, a barcode 101, and an advertising region 103 are included in FIG. 9.

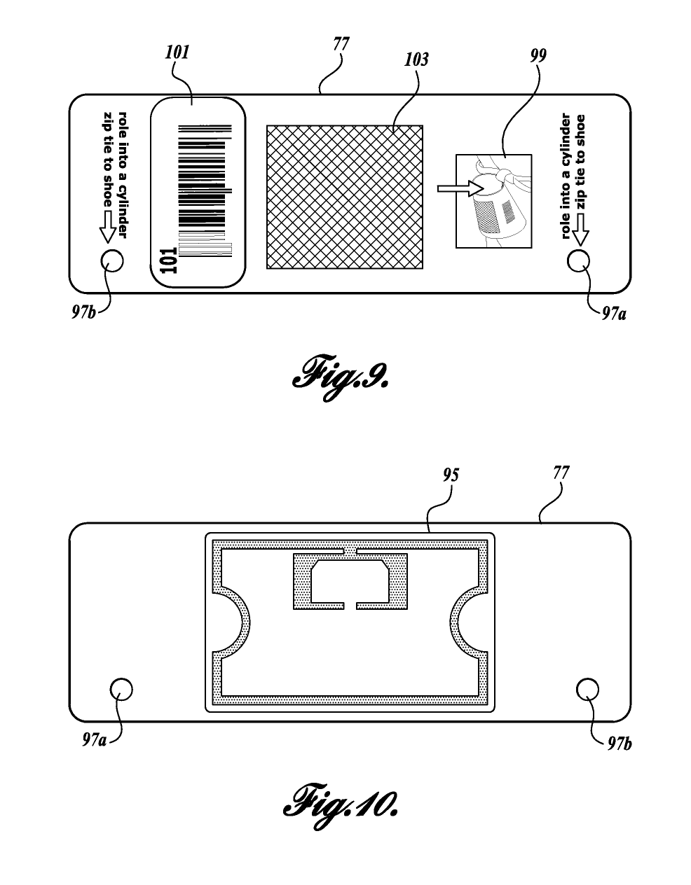

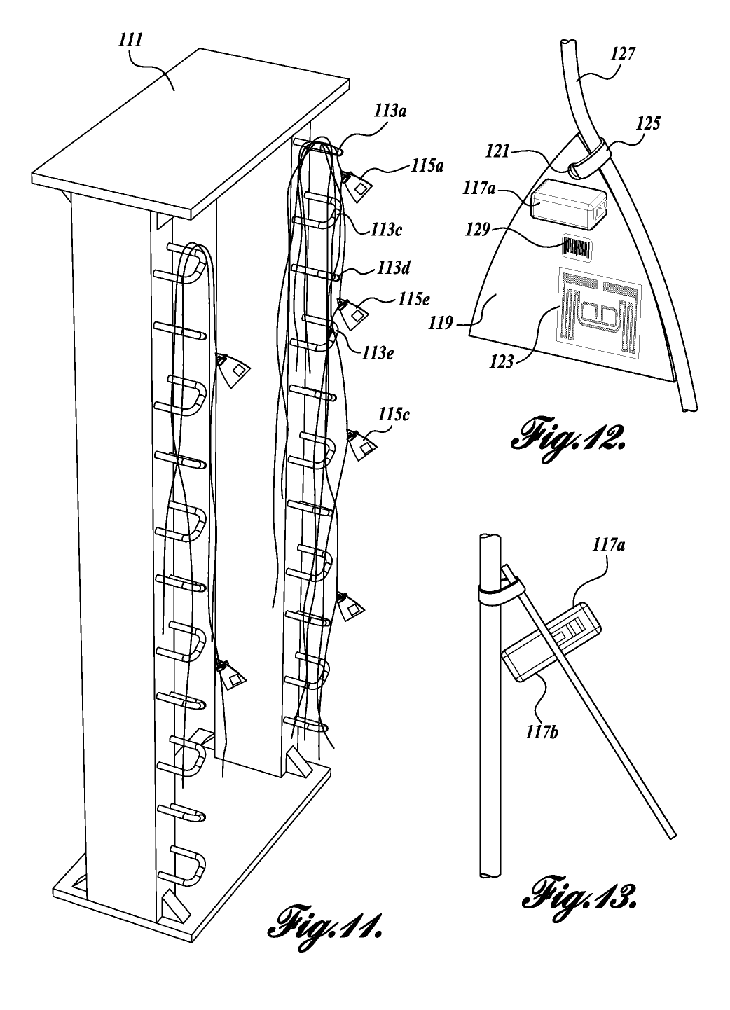

FIGS. 11-13 illustrate a further alternative embodiment generally similar to the embodiment illustrated in FIGS. 1-6, except that the embodiment is used to identify wires, either separate wires (shown) or multiple wires (not shown) of a wire harness. More specifically, FIG. 11 illustrates a support structure 111 having a plurality of U-shaped supports 113a, 113b, 113c, . . . suitable for supporting the wires of a product such as an airplane, boat, automobile, truck, etc. Attached to a single wire, or an associated set of wires, are supported RFID tags 115a, 115b, 115c, . . . As with the FIGS. 1-6 embodiment, each of the supported RFID tags 115a, 115b, 115c, . . . includes an aligned pair of bumpers 117a and 117b located on the opposite side of a rigid, generally triangular-shaped sheet 119. As best shown in FIGS. 12 and 13, the bumpers are located near one of the corners of the generally triangular-shaped sheet 119. A hole 121 is located in the corner. Mounted on, or embedded in the sheet 119, is an RFID tag 123. Zip ties 125 are used to tightly attach the generally triangular-shaped sheets 119 to a wire or wire bundle 127 via the hole 121. The tight attachment is such that the underlying bumper 117b causes the sheet 119 to rotate outwardly. As a result, the antenna portion of the RFID tag, which is shown in outline in FIG. 12 and FIG. 13, is positioned away from the wire. The sheet 119 may also support a barcode 129 and, if desired, other identifying material, such as human-readable information about the associated wire 127.

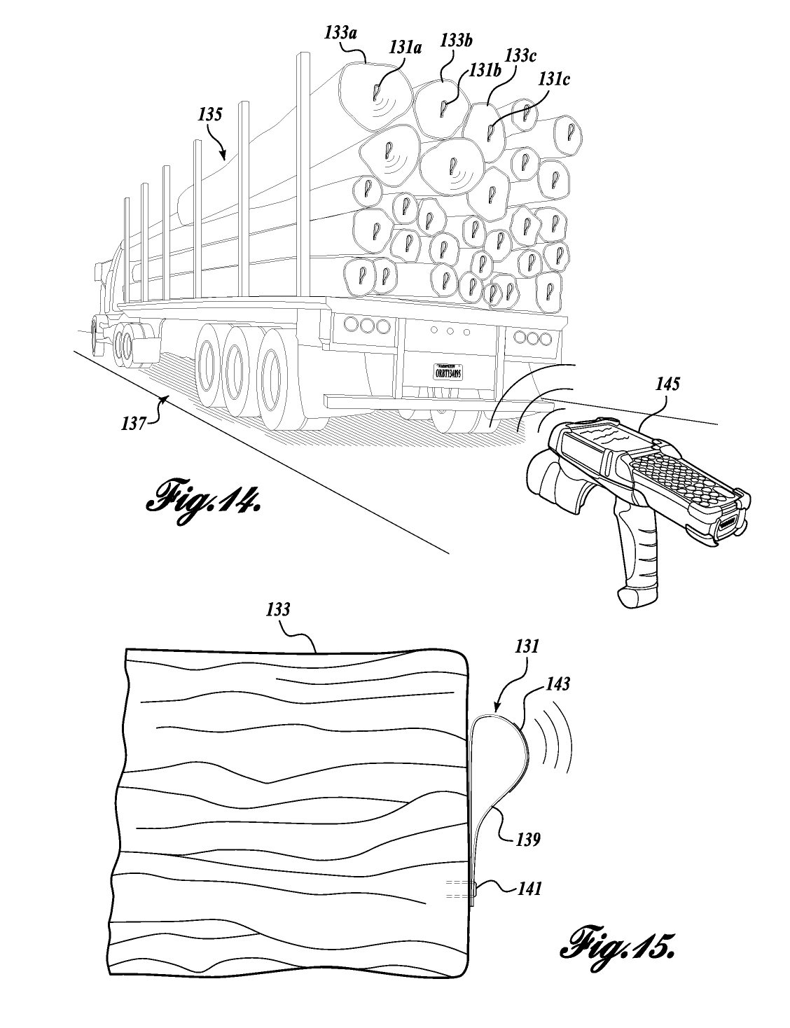

FIGS. 14 and 15 illustrate a further embodiment. In this embodiment, a supported RFID tag 131a, 131b, 131c, . . . is attached to the ends of logs 133a, 133b, 133c, . . . being transported by the trailer 135 of a logging truck 137. As shown best in FIG. 15, the support 139 of each of the support RFID tags 131a, 131b, 131c, . . . is elongate and formed of a semi-rigid material, such as a semi-rigid plastic. The supports are formed into a loop by placing the inside surfaces of the long ends against one another. The overlapping ends are affixed to the end of a log 133 by, for example, a staple 141. An RFID tag 143, including the antenna portion, is located on the outer portion of the loop. As a result, the antenna portion of the RFID tag is spaced away from the end of the log 133. Also shown in FIG. 14 is a reader 145 designed to read information from the RFID tags attached by the supports to the ends of the logs 133a, 133b, 133c.

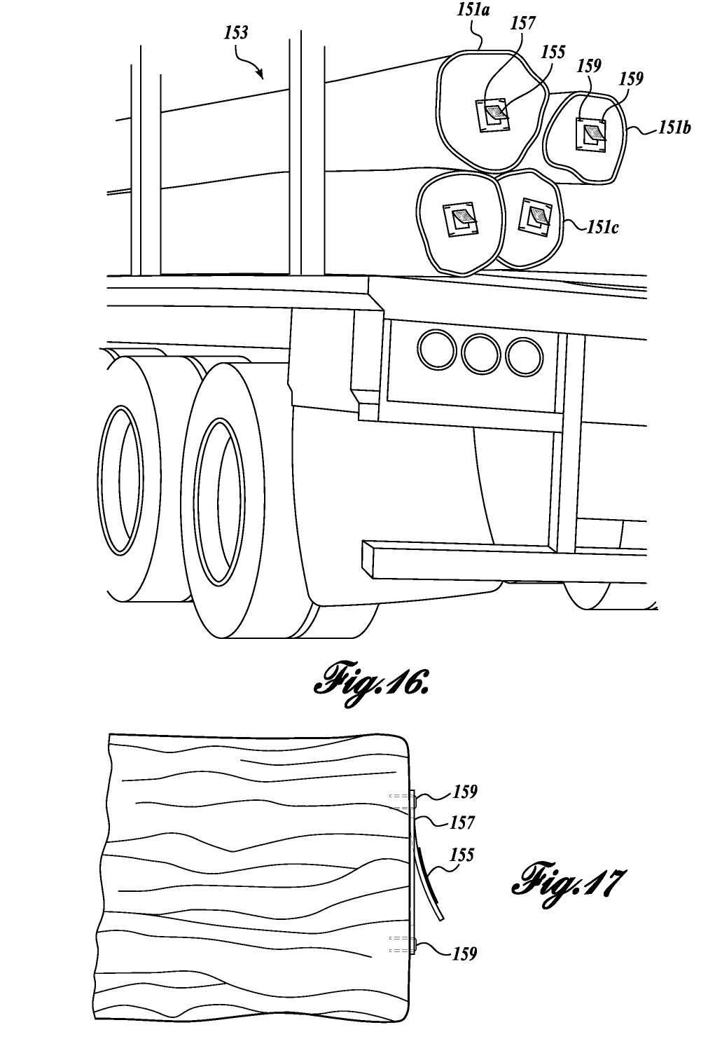

FIGS. 16 and 17 illustrate an application similar to the application illustrated in FIGS. 14 and 15, i.e., supported RFID tags affixed to the ends of logs 151a, 151b, 151c being transported by the trailer 153 of a logging truck. However, rather than the RFID tags being mounted on an elongate loop of semi-rigid material, the RFID tags, including the antenna portion of the RFID tags (not shown), are mounted on (or embedded in) flaps 155 that extend outwardly from surrounding planar sections 157. The surrounding planar sections 157 are attached to the ends of the logs by staples 159, for example. The surrounding planar sections and the integral tags are formed of suitably rigid materials, such as a suitably rigid plastic, for example. Because the flaps on which the antenna portion of the RFID tags are mounted extend outwardly from the ends of the logs, the antenna portions are spaced from the end of the logs.

As will be readily appreciated from the foregoing description, all of the various embodiments include a support that positions an RFID tag away from an object to be identified. This spacing allows the RFID tag to be more easily read and, thus, improves the use of RFID tags to identify associated objects.

While preferred embodiments have been illustrated and described, it will be appreciated that the various embodiments can be modified in various ways. For example, rather than the various supports being formed of plastic, they can be formed of other suitable materials. Thus, within the scope of the appended claims, it will be understood that the disclosed subject matter can be practiced otherwise than as specifically described herein.

The embodiments of the invention in which an exclusive property or privilege is claimed are defined as follows:

1. A supported radio frequency identification (RFID) tag comprising:
a support including a support sheet for supporting an RFID tag;
an RFID tag supported by support, said RFID tag including an antenna portion, said antenna portion located in a predetermined area of said support; and
an attachment device for attaching said support to an object to be identified by said RFID tag;
wherein said support is formed such that when said attachment device attaches said support to an object to be identified by said RFID tag, the antenna portion of said RFID tag is spaced away from the object.

2. A supported radio frequency identification (RFID) tag as claimed in claim 1, wherein said support also includes at least one bumper affixed to one side of the support sheet.

3. A supported radio frequency identification (RFID) tag as claimed in claim 2, wherein said at least one bumper is located near one end of said support sheet and wherein said antenna portion of said RFID tag is located on the other end of said support sheet.

4. A supported radio frequency identification (RFID) tag as claimed in claim 3, wherein said one end of said support sheet includes a hole.

5. A supported radio frequency identification (RFID) tag as claimed in claim 4, wherein said attachment device includes a tie for attaching said support sheet to said object to be identified by said RFID tag via said hole such that when said tie tightly attaches said support sheet to said object to be identified by said RFID tag, said bumper acts as a fulcrum that rotates the end of said support sheet that includes said antenna portion of said RFID tag outwardly, away from said object.

6. A supported radio frequency identification (RFID) tag as claimed in claim 5, wherein said RFID tag, including said antenna portion, is layered onto said support sheet.

7. A supported radio frequency identification (RFID) tag as claimed in claim 5, wherein said RFID tag, including said antenna portion, is embedded in said support sheet.

8. A supported radio frequency identification (RFID) tag as claimed in claim 1, wherein said RFID tag, including said antenna portion, is layered onto said support sheet.

9. A supported radio frequency identification (RFID) tag as claimed in claim 1, wherein said RFID tag, including said antenna portion, is embedded in said support sheet.

10. A supported radio frequency identification (RFID) tag as claimed in claim 1, wherein said support sheet is elongate, wherein the ends of said elongate sheet are joined such that said elongate is rotated into a cylinder shape and wherein said RFID tag is located in a region of said cylinder remote from the ends of said sheet.

11. A supported radio frequency identification (RFID) tag as claimed in claim 10, wherein said support sheet is elongate and includes holes at opposite ends of said elongate sheet that are alignable with one another when said sheet is rotated into said cylinder and wherein said attachment devices attaches said support to said object to be identified by said RFID tag via a tie that passes through said aligned holes.

12. A supported radio frequency identification (RFID) tag as claimed in claim 11, wherein said tie is a zip tie.

13. A supported radio frequency identification (RFID) tag as claimed in claim 1, wherein said support sheet is elongate, wherein the ends of said sheet are joined such that said elongate sheet is rotated into a truncated cone shape and wherein said RFID tag is located in a region of said truncated cone remote from the ends of said sheet.

14. A supported radio frequency identification (RFID) tag as claimed in claim 13, wherein said support sheet is elongate and includes holes at opposite ends of said elongate sheet that are alignable with one another when said sheet is rotated into said truncated cone and wherein said attachment devices attaches said support to said object to be identified by said RFID tag via a tie that passes through said aligned holes.

15. A supported radio frequency identification (RFID) tag as claimed in claim 14, wherein said tie is a zip tie.

16. A supported radio frequency identification (RFID) tag as claimed in claim 1, wherein said support sheet is elongate and the inner surfaces of the ends of said elongate sheet are juxtaposed to one another such that said elongate support becomes a loop and wherein said antenna portion of said RFID tag is located such that when the ends of said loop are attached to said object, said antenna portion is spaced away from said object.

17. A supported radio frequency identification (RFID) tag as claimed in claim 1, wherein said support sheet is generally planar and includes an outwardly extending tab and wherein said antenna portion of said RFID tag is located on said outwardly extending tab.

18. A supported radio frequency identification (RFID) tag as claimed in claim 1, wherein said RFID tag is mounted on said support sheet.

19. A supported radio frequency identification (RFID) tag as claimed in claim 1, wherein said RFID tag is embedded in said support sheet.

20. A supported radio frequency identification (RFID) tag as claimed in claim 1, wherein said attachment device comprises a hole in said support sheet and a tie for tying said support sheet to said object to be identified by said RFID tag via said hole.
